(19) United States
(12) Patent Application Publication
(10) Pub. No.: US 2025/0190917 A1
(43) Pub. Date: Jun. 12, 2025

(54) METHOD, APPARATUS AND ELECTRONIC DEVICE FOR BUSINESS PROCESSING

(71) Applicants: Beijing Zitiao Network Technology Co., Ltd., Beijing (CN); Lemon Inc., Grand Cayman (KY)

(72) Inventors: Houtong Zhang, Beijing (CN); Siming Zhao, Los Angeles, CA (US); Linlin Pan, Beijing (CN)

(21) Appl. No.: 18/793,602

(22) Filed: Aug. 2, 2024

(30) Foreign Application Priority Data
Dec. 11, 2023 (CN) 202311692389.6

(51) Int. Cl. G06Q 10/0639

(52) U.S. Cl. CPC G06Q 10/06393

(57) ABSTRACT

Embodiments of the disclosure provide a method, apparatus and electronic device for business processing. The method includes: obtaining a plurality of performance indicators associated with a business indicator; determining, in the plurality of performance indicators, a target performance indicator with a multicollinearity problem; determining a first performance indicator; determining a first regression coefficient between the target performance indicator and the first performance indicator; determining a plurality of second regression coefficients between the business indicator and a plurality of second performance indicators; and restoring a regression coefficient of the target performance indicator to the business indicator based on the first regression coefficient and the plurality of second regression coefficients, the regression coefficient of the target performance indicator to the business indicator being directly proportional to a degree of impact of the target performance indicator on the business indicator.

### CROSS REFERENCE

The present application claims priority to Chinese Patent Application No. 202311692389.6, filed on Dec. 11, 2023 and entitled “METHOD, APPARATUS AND ELECTRONIC DEVICE FOR BUSINESS PROCESSING”, the entirety of which is incorporated herein by reference.

### FIELD

Embodiments of the present disclosure relate to the field of computer technology, and in particular, to a method, apparatus and electronic device for business processing.

### BACKGROUND

Performance indicators of an application may impact business indicators of the application. For example, the definition of video playback (a performance indicator) may impact the number of daily active users of the application (a business indicator).

Currently, an electronic device may process business indicators and multiple performance indicators based on linear regression to obtain a regression coefficient of each performance indicator, and then determine the degree of impact of the performance indicator on the business indicators based on the regression coefficient. However, when the correlation between some performance indicators is relatively high, in order to avoid the multicollinearity problem, the electronic device may retain only one performance indicator among the performance indicators with high correlation and remove other performance indicators during linear regression processing, thereby performing linear regression processing on the remaining performance indicators. However, in this way, the electronic device may not determine the regression coefficient of the removed performance indicators on the business indicators, resulting in the inability to determine the degree of impact of the performance indicators on the business indicators.

### SUMMARY

The present disclosure provides a method, apparatus and electronic device for business processing to solve one or more technical problems in the prior art.

In a first aspect, the present disclosure provides a method for business processing and the method for business processing includes:
obtaining a plurality of performance indicators associated with a business indicator;
determining, in the plurality of performance indicators, a target performance indicator with a multicollinearity problem;
determining a first performance indicator, a correlation of the first performance indicator and the target performance indicator being greater than or equal to a first threshold;
determining a first regression coefficient between the target performance indicator and the first performance indicator;
determining a plurality of second regression coefficients between the business indicator and a plurality of second performance indicators, the second performance indicators being performance indicators other than the target performance indicator among the plurality of performance indicators; and
restoring a regression coefficient of the target performance indicator to the business indicator based on the first regression coefficient and the plurality of second regression coefficients, the regression coefficient of the target performance indicator to the business indicator being directly proportional to a degree of impact of the target performance indicator on the business indicator.

In a second aspect, the present disclosure provides an apparatus for business processing and the apparatus for business processing includes a first obtaining module, a first determining module, a second determining module, a third determining module, a fourth determining module and a fifth determining module, where:
the first obtaining module is configured to obtain a plurality of performance indicators associated with a business indicator;
the first determining module is configured to determine, in the plurality of performance indicators, a target performance indicator with a multicollinearity problem;
the second determining module is configured to determine a first performance indicator, a correlation of the first performance indicator and the target performance indicator being greater than or equal to a first threshold;
the third determining module is configured to determine a first regression coefficient between the target performance indicator and the first performance indicator;
the fourth determining module is configured to determine a plurality of second regression coefficients between the business indicator and a plurality of second performance indicators, the second performance indicators being performance indicators other than the target performance indicator among the plurality of performance indicators; and
the fifth determining module is configured to restore a regression coefficient of the target performance indicator to the business indicator based on the first regression coefficient and the plurality of second regression coefficients, the regression coefficient of the target performance indicator to the business indicator being directly proportional to a degree of impact of the target performance indicator on the business indicator.

In a third aspect, embodiments of the present disclosure provide an electronic device including: a processor and a memory;
where the memory stores a computer-executed instruction; and
the processor executes the computer-executed instruction stored in the memory, causing the processor to perform the method of business processing of the above first aspect and the various possible involvements in the first aspect.

In a fourth aspect, embodiments of the present disclosure provide a computer-readable storage medium wherein the computer-readable storage medium stores a computer-executed instruction, and the computer-executed instruction, when executed by a processor, implements the method of business processing of the above first aspect and the various possible involvements in the first aspect.

The present disclosure provides a method, apparatus and electronic device for business processing. The electronic device may obtain a plurality of performance indicators associated with a business indicator, determine, in the plurality of performance indicators, a target performance indicator with a multicollinearity problem, determine a first performance indicator, a correlation of the first performance indicator and the target performance indicator being greater than or equal to a first threshold, determine a first regression coefficient between the target performance indicator and the first performance indicator, determine a plurality of second regression coefficients between the business indicator and a plurality of second performance indicators, the second performance indicators being performance indicators other than the target performance indicator among the plurality of performance indicators. The electronic device may restore a regression coefficient of the target performance indicator to the business indicator based on the first regression coefficient and the plurality of second regression coefficients, the regression coefficient of the target performance indicator to the business indicator being directly proportional to a degree of impact of the target performance indicator on the business indicator. In the above method, since the first regression coefficient is the first regression coefficient between the target performance indicator and the first performance indicator with high correlation, the electronic device may determine the relationship between the first performance indicator and the target performance indicator based on the first regression coefficient, and the plurality of second regression coefficients may indicate the relationship between the first performance indicator and the business indicator. Therefore, even if the electronic device removes the target performance indicator and then performs linear regression processing on the business indicator and the plurality of second performance indicators (the regression coefficients of the target performance indicator to the business indicator may not be obtained), the electronic device may accurately determine the degree of the impact of the target performance indicator on the business indi cator based on the first regression coefficient and the plurality of second regression coefficients.

### BRIEF DESCRIPTION OF THE DRAWINGS

In order to more clearly illustrate the embodiments of the present disclosure or the technical solutions in the prior art, a brief introduction will be made below to the drawings that need to be used in the description of the embodiments or the prior art. It is obvious that the accompanying drawings in the following description are some embodiments of the present disclosure. For those skilled in the art, other accompanying drawings may be obtained based on these drawings without the need for creative labor.

FIG. 1 is a schematic diagram of an application scenario provided by embodiments of the present disclosure;

FIG. 2 is a schematic flow chart of a method of business processing provided by embodiments of the present disclosure;

FIG. 3 is a schematic diagram of a process of determining a first regression coefficient provided by embodiments of the present disclosure;

FIG. 4 is a schematic diagram of a process of determining a plurality of second performance indicators provided by embodiments of the present disclosure;

FIG. 5 is a schematic diagram of a process of determining a regression coefficient provided by embodiments of the present disclosure;

FIG. 6 is a schematic diagram of a method of verifying the regression coefficient provided by embodiments of the present disclosure;

FIG. 7 is a schematic diagram of a process of determining a third regression coefficient provided by embodiments of the present disclosure;

FIG. 8 is a schematic diagram of a process of verifying regression coefficient provided by embodiments of the present disclosure;

FIG. 9 is a schematic structural diagram of an apparatus for business processing provided by embodiments of the present disclosure;

FIG. 10 is a schematic structural diagram of another apparatus for business processing provided by embodiments of the present disclosure; and

FIG. 11 is a schematic structural diagram of an electronic device provided by embodiments of the present disclosure.

### DETAILED DESCRIPTION

In order to make the purpose, technical solutions and advantages of the embodiments of the present disclosure clearer, the technical solutions of the embodiments of the present disclosure will be clearly and completely described below in conjunction with the drawings in the embodiments of the present disclosure. Obviously, the described embodiments are a part of embodiments of the present disclosure, not all embodiments. Based on the embodiments in the present disclosure, all other embodiments obtained by those of ordinary skill in the art without creative efforts fall within the scope of protection of the present disclosure.

In order to facilitate understanding, the concepts involved in embodiments of the present disclosure are explained below.

Electronic device: a device with wireless sending and receiving functions. The electronic device may be deployed on land, including indoors or outdoors, handheld, wearable, or vehicle-mounted. The electronic device may be a mobile phone, tablet computer (Pad), computer with wireless transceiver function, virtual reality (VR) electronic device, augmented reality (AR) electronic device, wireless terminal in industrial control, vehicle-mounted electronic device, wireless terminal in self-driving, wireless electronic device in remote medical, wireless electronic device in smart grid, wireless electronic device in transportation safety, wireless electronic device in smart city, wireless electronic device in smart home, wearable electronic devices, etc. The electronic devices involved in the embodiments of the present disclosure may also be referred to as terminal, user equipment (UE), access electronic device, vehicle-mounted terminal, industrial control terminal, UE unit, UE station, mobile radio station, mobile station, remote station, remote electronic device, mobile device, UE electronic device, wireless communication device, UE agent or UE apparatus, etc. The electronic devices may also be stationary or mobile.

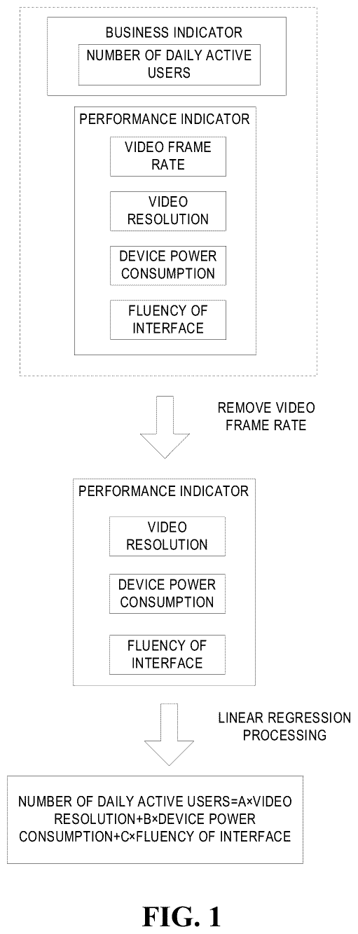

In the following, with reference to FIG. 1, application scenarios of embodiments of the present disclosure will be described.

FIG. 1 is a schematic diagram of an application scenario provided by embodiments of the present disclosure. Refer to FIG. 1, which include a business indicator and performance indicators. The business indicator includes the number of daily active users, and the performance indicators related to this business indicator include video frame rate, video definition, device power consumption, and interface fluency. Since the correlation between video frame rate and video definition is high, before performing linear regression, the electronic device (not shown in FIG. 1) may remove the video frame rate and retain the video definition. The electronic device may perform linear regression processing on the number of daily active users, video definition, device power consumption and interface fluency, and obtain the number of daily active users=A×video definition+B×device power consumption+C×interface fluency, where A may indicate the degree of impact of video definition on the number of daily active users, B may indicate the degree of impact of device power consumption on the number of daily active users, and C may indicate the degree of impact of interface fluency on the number of daily active users. However, this method may not obtain the degree of impact of the video frame rate on the number of daily active users, and thus it may not indicate the optimization direction of electronic devices for video frame rate.

It should be noted that FIG. 1 is only an example of the application scenarios of embodiments of the present disclosure and does not limit the application scenarios of embodiments of the disclosure.

In related art, performance indicators of an application may affect the business indicator of the application. Therefore, the electronic device needs to determine the degree of impact of the performance indicators on the business indicator. For example, the definition of video playback of an application (performance indicator) may affect the number of daily active users of the application (business indicator). However, the electronic device needs to accurately determine the degree of impact of definition of video playback on the number of daily active users. Currently, the electronic device may process the business indicator and a plurality of performance indicators based on linear regression to obtain the regression coefficient of each performance indicator, where the regression coefficient may indicate the degree of impact of the performance indicator on the business indicator.

However, the correlation between some performance indicators is high. For example, the correlation between the definition of video playback and video frame rate is high. When electronic device performs linear regression processing on a plurality of performance indicators with high correlation, the multicollinearity problem may be caused. In order to avoid the multicollinearity problem, the electronic device may retain only one performance indicator among highly relevant performance indicators, remove other performance indicators, and then perform linear regression processing on the remaining performance indicator. For example, the business indicator is related to a performance indicator 1, a performance indicator 2 and a performance indicator 3, and if the performance indicator 1 is related to the performance indicator 2, the electronic device may remove the performance indicator 1 and perform linear regression processing on the business indicator, the performance indicator 2 and the performance indicator 3, to obtain the regression coefficients of performance indicator 2 and performance indicator 3 on business indicators. However, the electronic device may not determine the regression coefficient between the performance indicator 1 and the business indicator, making it impossible for the electronic device to determine the degree of impact of the performance indicator 1 on business indicator. In this way, the electronic device may not accurately determine the degree of impact of performance indicators on the business indicator.

In order to solve the technical problems in the related art, embodiments of the present disclosure provide a method for business processing. The electronic device may obtain a plurality of performance indicators associated with a business indicator, determine, in the plurality of performance indicators, a target performance indicator with a multicollinearity problem. The electronic device may determine a first performance indicator, a correlation of the first performance indicator and the target performance indicator being greater than or equal to a first threshold, determine a first regression coefficient between the target performance indicator and the first performance indicator. The electronic device may determine a plurality of second regression coefficients between the business indicator, and for any first performance indicator, determine a target regression coefficient associated with the first performance indicator, in the plurality of second regression coefficients and determine a ratio of the target regression coefficient to the first regression coefficient of the first performance indicator as the regression coefficient of the target performance indicator to the business indicator. In this way, since the first regression coefficient may indicate the relationship between performance indicators and target performance indicator, and the target regression coefficient may indicate the relationship between the performance indicator and the business indicator. Therefore, the electronic device may accurately determine the regression coefficient between target performance indicators and business indicator based on the first regression coefficient and target regression coefficient, thereby accurately determining the degree of impact of the target performance indicator on the business indicator.

The technical solution of the present disclosure and how the technical solution of the present disclosure solves the above technical problems will be described in detail below with specific embodiments. The following specific embodiments may be combined with each other, and the same or similar concepts or processes may not be repeated in some embodiments. The embodiments of the present disclosure will be described below with reference to the accompanying drawings.

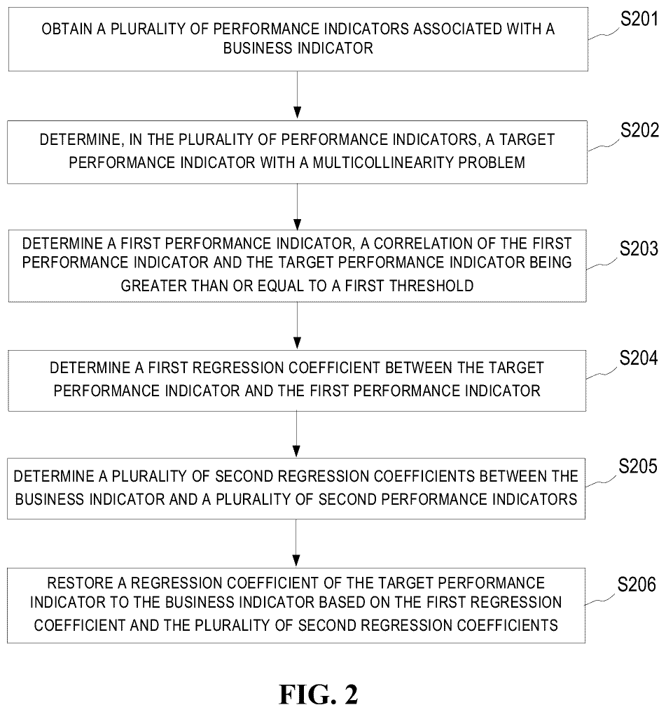

FIG. 2 is a schematic flow chart of a method for business processing provided by embodiments of the present disclosure. Refer to FIG. 2, the method may include:

In S201, a plurality of performance indicators associated with a business indicator are obtained.

The execution body of the embodiments of the present disclosure may be an electronic device or an apparatus for business processing set in the electronic device. The apparatus for business processing may be implemented based on software, and the apparatus for business processing may also be implemented based on a combination of software and hardware, and embodiments of the present disclosure do not limit this. Alternatively, the electronic device can be any device with computing capabilities. For example, the electronic device may be a computer, a server, and other devices, and the embodiments of the present disclosure do not limit this.

Alternatively, the business indicator may be used to indicate the performance of an application on the business side. For example, the business indicator may include the number of daily active users of the application, and the business indicator may also include the number of times a user uses the application within a historical period, etc. Embodiments of the present disclosure does not limit this.

Alternatively, performance indicators may be used to indicate performance of an application. For example, performance indicators may include client performance indicators, playback performance indicators, and production-side performance indicators. For example, client performance indicators may include the fluency of the user interface (UI) in the application, dynamic resources (power consumption, etc.) and static resources (storage space, etc.), which are not limited by the embodiments of the present disclosure. For example, the playback performance indicators may include the playback frame rate of the video, the playback definition of the video, etc., which are not limited by the embodiments of the present disclosure.

Alternatively, a plurality of performance indicators may be associated with the business indicator. For example, a plurality of performance indicators may impact the business indicator. For example, the application may include a performance indicator 1, a performance indicator 2 and a performance indicator 3. If the performance indicator 1 and the performance indicator 2 change, the business indicator may also change, the electronic device may determine that the performance indicator associated with the business indicator is the performance indicator 1 and performance indicator 2. If the business indicator does not change when the performance indicator 3 changes, the electronic may can determine that performance indicator 3 is not related to the business indicator, that is, the performance indicator 3 cannot impact the business indicator.

Alternatively, the electronic device may obtain a plurality of performance indicators associated with the business indicator based on the corresponding relationship between the business indicator and a plurality of performance indicators. For example, a business indicator 1 may correspond to a performance indicator a and a performance indicator b, a business indicator 2 may correspond to a performance indicator c and a performance indicator d, and the electronic device may determine a plurality of performance indicators associated with the business indicator based on the corresponding relationship.

It should be noted that the same business indicator may be associated with a plurality of groups of performance indicators, and each group of performance indicators may include a plurality of performance indicators. For example, the business indicator may be associated with the performance indicator 1 and the performance indicator 2, and the business indicator may also be associated with the performance indicator 3 and the performance indicator 4, where the performance indicator 1 and the performance indicator 2 may be performance indicators in the direction of a business line (such as performance indicators in the direction of comment optimization), and the performance indicator 3 and the performance indicator 4 may be performance indicators in the direction of another business line (such as performance indicators in the direction of video optimization). Specifically, the electronic device may determine a plurality of performance indicators associated with a business indicator based on business needs. For example, if the electronic device needs to increase the number of daily active users based on comment optimization, the plurality of performance indicators associated with the business indicator may be performance indicators related to comment optimization. If the electronic device needs to increase the number of daily active users based on video optimization, the plurality of performance indicators associated with the business indicator may be performance indicators related to video optimization.

It should be noted that the electronic device may obtain a plurality of performance indicators associated with the business indicators based on any feasible implementation, and embodiments of the present disclosure do not limit this.

In S202, a target performance indicator with a multicollinearity problem is determined in the plurality of performance indicators.

Multicollinearity may refer to that the model estimation is distorted or difficult to estimate accurately due to the existence of precise or highly correlated relationships between the explanatory variables in the linear regression model. For example, if the correlation between the performance indicator 1 and the performance indicator 2 is high, there will be a multicollinearity problem when performing linear regression on the business indicator, the performance indicator 1, and the performance indicator 2, resulting in the inability of electronic devices to obtain the regression coefficient for each performance indicator.

The target performance indicator may be a performance indicator with a multicollinearity problem. For example, if the performance indicator 1 is video frame rate and the performance indicator 2 is video resolution, then the electronic device may determine that the correlation between the performance indicator 1 and the performance indicator 2 is high, and the electronic device may determine the performance indicator 1 or the performance indicator 2 as the target performance indicator with the multicollinearity problem.

Alternatively, the electronic device may determine the target performance indicator with the multicollinearity problem based on the following feasible implementations: for any of the performance indicators, determining a variance inflation coefficient between the performance indicator and each of other performance indicators of the performance indicators, in response to any variance inflation factor being greater than or equal to a second threshold, determining the performance indicator as the target performance indicator.

For example, if the plurality of performance indicators associated with the business indicator include the performance indicator 1, the performance indicator 2 and the performance indicator 3, and if the variance inflation coefficient between performance indicator 1 and performance indicator 2 is greater than or equal to the second threshold, the electronic device may determine the performance indicator 1 or the performance indicator 2 as the target performance indicator.

The variance inflation factor (VIF) may indicate the correlation between two performance indicators in linear regression. For example, the VIF value may indicate the severity of multicollinearity in a multivariable linear regression model. If the VIF value between the performance indicator 1 and the performance indicator 2 is greater than or equal to a predetermined threshold, it means that the correlation between the performance indicator 1 and the performance indicator 2 is high, and there will be a multicollinearity problem when the electronic device performs linear regression. In this way, the electronic device may accurately determine the target performance indicator with the multicollinearity problem based on the VIF value of the performance indicator.

It should be noted that the electronic device may also determine a plurality of first performance indicators among multiple a plurality of indicators based on any feasible implementations, and embodiments of the present disclosure do not limit this.

It should be noted that in the process of actual application, there may be a plurality of target performance indicators with the multicollinearity problem among the plurality of performance indicators associated with the business indicator. For example, the performance indicators associated with the business indicator include the performance indicator 1, the performance indicator 2, the performance indicator 3 and the performance indicator 4. The correlation between the performance indicator 1 and the performance indicator 2 is relatively high, and the correlation between the performance indicator 3 and the performance indicator 4 is relatively high, and thus the electronic device may determine that the target performance indicator may be the performance indicator 1 or the performance indicator 2, and the target performance indicator may also be the performance indicator 3 or the performance indicator 4. When conducting multivariable linear regression, there is no multicollinearity problem among the plurality of performance indicators.

In S203, a first performance indicator is determined where a correlation of the first performance indicator and the target performance indicator is greater than or equal to a first threshold.

The correlation between the first performance indicator and the target performance indicator is greater than or equal to the first threshold. For example, if the performance indicator 1 is a target performance indicator with the multicollinearity problem, the correlation between the performance indicator 2 and the performance indicator 1 is equal to the first threshold, and the correlation between the performance indicator 3 and the performance indicator 1 is greater than the first threshold, then the electronic device may determine that the first performance indicator of the target performance indicator includes the performance indicator 2 and the performance indicator 3. It should be noted that the performance indicator 2 and performance indicator 3 may be completely independent.

It should be noted that the electronic device may determine the first performance indicator, a correlation of the first performance indicator and the target performance indicator being greater than or equal to a first threshold based on any feasible implementations (for example, if the VIF value between a performance indicator and the target performance indicator is greater than a predetermined value, the electronic device determines that the performance indicator is related to the target performance indicator), and embodiments of the present disclosure do not limit this.

In S204, a first regression coefficient between the target performance indicator and the first performance indicator is determined.

The first regression coefficient may indicate the degree of impact of the first performance indicator on the target performance indicator. For example, the first performance indicator may include the performance indicator 1 and the performance indicator 2. If the electronic device determines that the target performance indicator is the performance indicator 3, then the first regression coefficient of performance indicator 1 may indicate the degree of impact of the performance indicator 1 on the performance indicator 3, and the first regression coefficient of the performance indicator 2 may indicate the degree of impact of the performance indicator 2 on the performance indicator 1.

Alternatively, the electronic device may process the target performance indicator and the first performance indicator based on a multivariable linear regression method, thereby obtaining a plurality of first regression coefficients. For example, the target performance indicator may be the performance indicator 1, the first performance indicator related to the target performance indicator may be the performance indicator 2 and the performance indicator 3, and the electronic device may perform linear regression processing on the performance indicator 1 (dependent variable), the performance indicator 2 (independent variable) and the performance indicator 3 (independent variable) to obtain the performance indicator 1=A (constant)+B×the performance indicator 2+C×the performance indicator 3+D (constant), where B may be the first regression coefficient of the performance indicator 2 and C may be the first regression coefficient of the performance indicator 3.

It should be noted that when the electronic device performs linear regression processing on the target performance indicator and the first performance indicator, the values of the target performance indicator and the first performance indicator may be obtained based on historical business data (which may be stored in the database), and embodiments of the present disclosure do not limit this.

It should be noted that the electronic device may also determine the first regression coefficient between the target performance indicator and the first performance indicator based on any other feasible implementations, and embodiments of the present disclosure do not limit this.

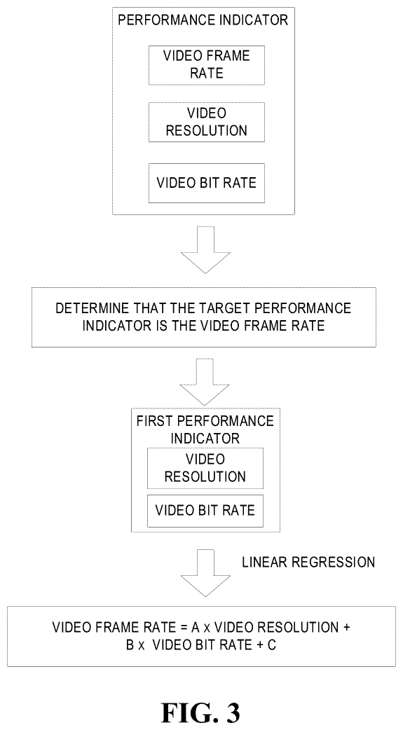

In the following, the process of determining the first regression coefficient will be described with reference to FIG. 3.

FIG. 3 is a schematic diagram of a process of determining the first regression coefficient provided by embodiments of the present disclosure. Refer to FIG. 3, performance indicators are included. The performance indicators may include video frame rate, video resolution and video bitrate. If there is a multicollinearity problem in the video frame rate, the electronic device (not shown in FIG. 3) may determine the video frame rate as the target performance indicator and determine the first performance indicator based on the video frame rate, where the first performance indicator includes the video resolution and video bitrate. The Electronic device may perform linear regression processing on video frame rate, video resolution and video bit rate, and obtain video frame rate=A×video resolution+B× video bitrate+C, where A and B are the first regression coefficients, and C is a constant. In this way, the electronic device may accurately determine the relationship between the target performance indicator and other first performance indicators based on the first regression coefficient.

In S205, a plurality of second regression coefficients between the business indicator and a plurality of second performance indicators are determined.

The second performance indicator may be performance indicators other than the target performance indicator among the plurality of performance indicators. For example, the performance indicators associated with the business indicator may include the performance indicator 1, the performance indicator 2, the performance indicator 3 and the performance indicator 4. If the VIF value between the performance indicator 3 and the performance indicator 4 is relatively high, the electronic device may determine the performance indicator 3 is the target performance indicator, and the performance indicator 4 is the first performance indicator related to the performance indicator 3. The electronic device may determine the plurality of performance indicators, which may include the performance indicator 1, the performance indicator 2, and the performance indicator 4

Alternatively, the second regression coefficient may indicate the degree of impact of the second performance indicator on the business indicator. For example, the greater the absolute value of the second regression coefficient, the greater the impact of the second performance indicator on the business indicator. The smaller the absolute value of the second regression coefficient, the smaller the impact of the second performance indicator on the business indicator.

Alternatively, the electronic device may determine a plurality of second regression coefficients between business indicator and a plurality of second performance indicators based on the following feasible implementations: removing the target performance indicator from the plurality of performance indicators to obtain the plurality of second performance indicators and performing regression processing on the business indicator and the plurality of second performance indicators to obtain the plurality of second regression coefficients corresponding to the plurality of second performance indicators. For example, after the electronic device determines a plurality of second performance indicators, the electronic device may perform multivariable linear regression processing on the business indicator and the plurality of second performance indicators, and then may obtain the second regression coefficient of each second performance indicator, and thus the degree of impact of the second performance indicator on the business indicator is determined based on the second regression coefficient of the second performance indicator.

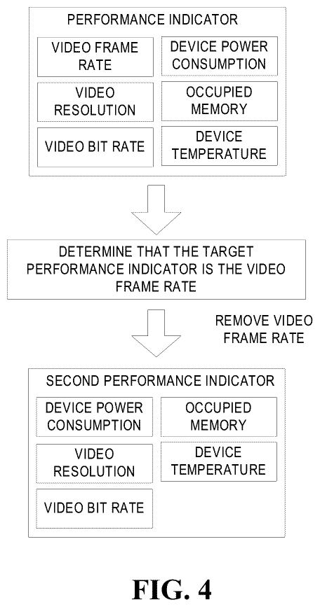

In the following, with reference to FIG. 4, the process of determining a plurality of second performance indicators by the electronic device will be described.

FIG. 4 is a schematic diagram of a process of determining a plurality of second performance indicators provided by embodiments of the present disclosure. See FIG. 4, performance indicators associated with the business indicator are included. The performance indicators may include video frame rate, video resolution, video bitrate, device power consumption, occupied memory, and device temperature. The electronic device (not shown in FIG. 4) may determine that the VIF value of the video frame rate and the video resolution is relatively high, and the VIF value of the video frame rate and the video bitrate is relatively high, and thus the electronic device may determine that the target performance indicator is the video frame rate, video resolution and video bitrate may be the first performance indicators of video frame rate. The electronic device may remove the video frame rate from the plurality of performance indicators to obtain second performance indicators, where the second performance indicators may include device power consumption, video resolution, video bitrate, occupied memory, and device temperature.

It should be noted that the electronic device may also determine a plurality of second regression coefficients between the business indicators and a plurality of second performance indicators based on any other feasible implementations, and the embodiments of the present disclosure do not limit this.

In S206, a regression coefficient of the target performance indicator to the business indicator is restored based on the first regression coefficient and the plurality of second regression coefficients.

The regression coefficient of the target performance indicator to the business indicator may indicate the degree of impact of the target performance indicator on the business indicator. For example, when the electronic device determines a plurality of second regression coefficients, in order to avoid the multicollinearity problem, the target performance indicator does not participate in the multivariable linear regression. Therefore, the electronic device may not obtain the regression coefficient of the target performance indicator. The electronic device needs determine the regression coefficient of the target performance indicator to the business indicator based on other ways.

The regression coefficient of the target performance indicator to the business indicator may be directly proportional to the degree of impact of the target performance indicator on the business indicator. For example, the greater the regression coefficient of the target performance indicator to the business indicator, the greater the degree of impact of the target performance indicator on the business indicator. The smaller the regression coefficient of the target performance indicator to the business indicator, the smaller the degree of impact of the target performance indicator on the business indicator.

The electronic device may determine the regression coefficient of the target performance indicator to the business indicator based on the following feasible implementations: for any first performance indicator, determining a target regression coefficient associated with the first performance indicator, in the plurality of second regression coefficients and determining a ratio of the target regression coefficient to the first regression coefficient of the first performance indicator as the regression coefficient of the target performance indicator to the business indicator.

The target regression coefficient may be the regression coefficient of the first performance indicator among the plurality of second regression coefficients. For example, for any first performance indicator, the first regression coefficient between the first performance indicator and the target performance indicator is the regression coefficient 1, and the second regression coefficient between the first performance indicator and the business indicator is the regression coefficient 2. The electronic device may determine the regression coefficient 2 as the target regression coefficient and determine the ratio of the regression coefficient 1 to the regression coefficient 2 as the regression coefficient of the target performance indicator to the business indicator. In this way, since the target regression coefficient may indicate the degree of impact of the first performance indicator on the business indicator and the first regression coefficient may indicate the degree of impact of the first performance indicator on the target performance indicator, the electronic device may accurately determine the degree of impact of the target performance indicator on the business based on the first regression coefficient and the target regression coefficient.

The following provides detailed explanations, through specific examples, of the process in which the electronic device determines the regression coefficient of the target performance indicator to the business indicator.

A business indicator y may be related to performance indicators x₁, x₂, x₃, x₄, where the VIF value between x₁ and x₂ is relatively high, the VIF value between x₁ and x₃ is relatively high, x₁ is the target performance indicator, and x₂ and x₃ are the first performance indicators.

The relationship between the business indicator and the plurality of second performance indicators may be:

y=β₀+β₂x₂+β₃x₃+β₄x₄+β₅x₅+ϵ
where y is the business indicator, β₀ and ϵ are constants, x₂, x₃, x₄, x₅ are performance indicators related to the business indicator respectively, β₂, β₃, β₄, β₅ are the regression coefficients of the performance indicators respectively. The business indicator is further related to the performance indicator x₁. However, due to the multicollinearity problem in x₁, the electronic device needs to remove x₁ (the target performance indicator) when conducting the linear regression.

The relationship between the target performance indicator and the first performance indicator may be:

x₁=c₀+c₂x₂+c₃x₃+ϵ
where x₁ is the target performance indicator, c₀ and ϵ are constants, x₂ and x₃ are the first performance indicators related to x₁, c₂ and c₃ are the regression coefficients of the first performance indicator.

Based on the above equation, the electronic device may determine the regression coefficient of x₁ to y (x₂ and x₃ are independent):

$${β}_{1} = {β}_{2} / {c}_{2} = {β}_{3} / {c}_{3}$$

where β₁ may be the regression coefficient of x₁ to y. In this way, the electronic device may accurately determine the regression coefficient of the target performance indicator to the business indicator based on the first regression coefficient and the second regression coefficient, and may further accurately determine the degree of impact of the target performance indicator on the business indicator.

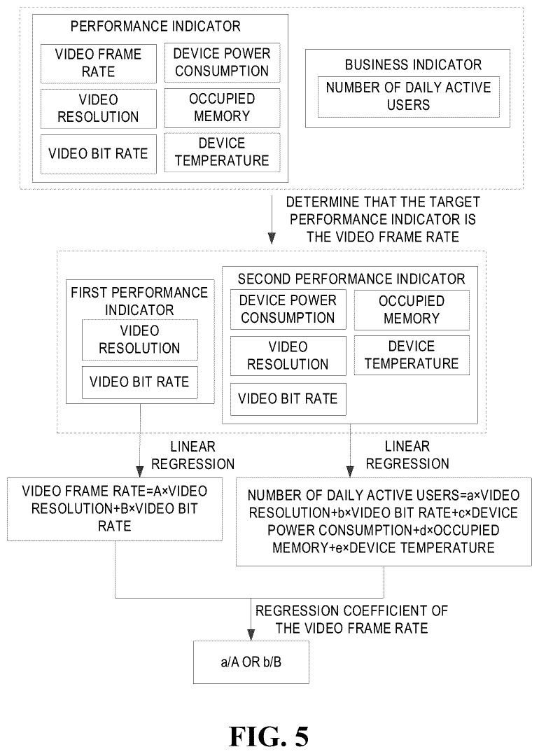

Next, with reference to FIG. 5, the process of determining the regression coefficient of the target performance indicator to the business indicator will be explained.

FIG. 5 is a schematic diagram of a process for determining the regression coefficient provided by the embodiments of the present disclosure. See FIG. 5, which includes a business indicator and performance indicators associated with the business indicator. The business indicator may be the number of daily active users, and the performance indicators may include video frame rate, video resolution, video bit rate, device power consumption, occupied memory and device problems. If the electronic device (not shown in FIG. 5) determines that the target performance indicator is the video frame rate, the electronic device may determine the first performance indicator and the second performance indicator. The first performance indicator includes video resolution and video bit rate, and the second performance indicator includes device power consumption, video resolution, video bit rate, occupied memory and device temperature.

Please refer to FIG. 5, the electronic device performs linear regression processing on the target performance indicator and the first performance indicator, and obtains Video frame rate=A×Video resolution+B×Video bit rate. The electronic device performs linear regression processing on the number of daily active users and the second performance indicator, and obtains The number of daily active users=a×Video resolution+b×Video bit rate+c×Device power consumption+d×Occupied memory+e×Device temperature. The electronic device may determine a/A or b/B as the regression coefficient of the video frame rate on the number of daily active users.

The embodiments of the present disclosure provide the method of business processing. The electronic device may obtain the plurality of performance indicators associated with the business indicator; the electronic device may determine, in the plurality of performance indicators, the target performance indicator with the multicollinearity problem; the electronic device may determine the first performance indicator, the correlation of the first performance indicator and the target performance indicator being greater than or equal to the first threshold; the electronic device may determine the first regression coefficient between the target performance indicator and the first performance indicator; the electronic device remove the target performance indicator from the plurality of performance indicators to obtain the plurality of second performance indicators; the electronic device may perform regression processing on the business indicator and the plurality of second performance indicators to obtain the plurality of second regression coefficients corresponding to the plurality of second performance indicators; for any first performance indicator, the electronic device may determine a target regression coefficient associated with the first performance indicator, in the plurality of second regression coefficients; and the electronic device may determine the ratio of the target regression coefficient to the first regression coefficient of the first performance indicator as the regression coefficient of the target performance indicator to the business indicator. Therefore, the electronic device, based on the target regression coefficient and the first regression coefficient of the performance indicator, may accurately determine the regression coefficient of the target performance indicator to the business indicator. In this way, even if the plurality of performance indicators have the multicollinearity problem, the electronic device may also obtain the degree of impact of each performance indicator on the business indicator, thereby improving an accuracy of the regression coefficient.

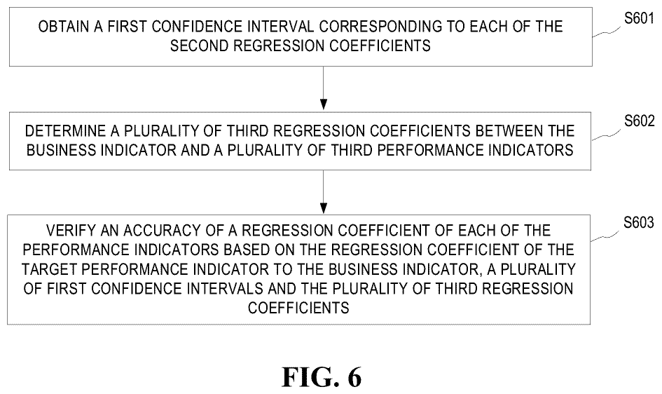

On the basis of the embodiments shown in FIG. 2, the above method of business processing further includes a method of verifying the accuracy of the regression coefficient of each of the performance indicators. In the following, in combination with FIG. 6, a detailed description of verifying the accuracy of the regression coefficient of each of the performance indicators is given.

FIG. 6 is a schematic diagram of a method for verifying the regression coefficient provided by the embodiments of the present disclosure. Please refer to FIG. 6, the method flow includes:

In S601, the first confidence interval corresponding to each of the second regression coefficients is obtained.

The first confidence interval may be the confidence interval corresponding to the second regression coefficient. For example, the confidence interval may represent the interval of the range of the sample estimated population mean, that is, the confidence interval may be the range within which the true value occurs, centered on the measured value, at a certain degree of confidence.

Alternatively, after the electronic device processes the plurality of second performance indicators based on the multivariable linear regression, not only the plurality of the second regression coefficients corresponding to the plurality of the second performance indicators may be obtained, but also the first confidence interval corresponding to each of the second regression coefficients may be obtained.

It should be noted that the electronic device may further determine the first confidence interval corresponding to each of the second regression coefficients based on any feasible implementation, and the embodiments of the present disclosure do not limit this.

In S602, a plurality of third regression coefficients between the business indicator and a plurality of third performance indicators are determined.

The third performance indicators include other performance indicators among the plurality of performance indicators except the first performance indicator. For example, the performance indicators associated with the business indicator may include performance indicator 1, performance indicator 2, performance indicator 3, performance indicator 4 and performance indicator 5. If the correlation between the performance indicator 3 and the performance indicator 4 as well as the performance indicator 5 is high, (the performance indicator 4 has a low correlation with the performance indicator 5), then the electronic device may determine the performance indicator 4 and the performance indicator 5 as the first performance indicator (the performance indicator 3 is the target performance indicator), and the electronic device may determine that the plurality of third performance indicators may include the performance indicator 1, the performance indicator 2 and the performance indicator 3.

The third regression coefficient may indicate the degree of impact of the third performance indicator on the business indicator. For example, the greater the absolute value of the third regression coefficient of the third performance indicator, the greater the degree of impact of the third performance indicator on the business indicator. The smaller the absolute value of the third regression coefficient of the third performance indicator, the smaller the degree of impact of the third performance indicator on the business indicator.

It should be noted that the electronic device may determine the plurality of third regression coefficients between the business indicator and the plurality of third performance indicators based on any feasible implementation, and the embodiments of the present disclosure do not limit this.

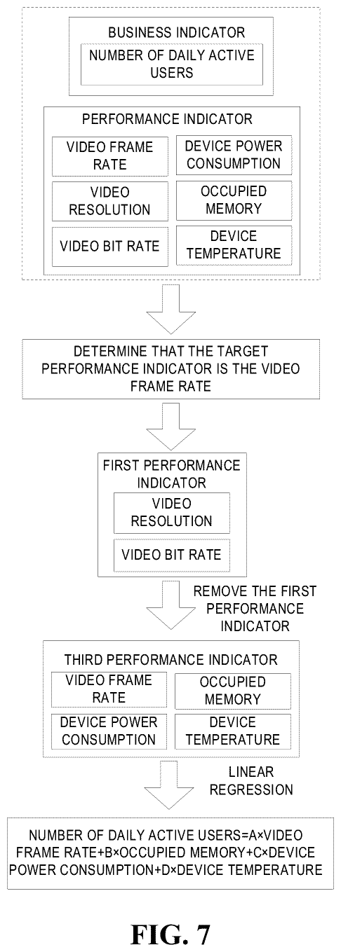

In the following, the process of determining the third regression coefficient will be described with reference to FIG. 7.

FIG. 7 is a schematic diagram of a process of determining the third regression coefficient provided by the embodiments of the present disclosure. See FIG. 7, which includes the business indicator and performance indicators associated with the business indicator. The business indicator may be the number of daily active users, and the performance indicators may include video frame rate, video resolution, video bit rate, device power consumption, occupied memory and device temperature. Because the VIF value of the video frame rate and the video resolution is relatively high, and the VIF value of the video frame rate and the video bit rate is relatively high, the electronic device (not shown in FIG. 7) may determine that the target performance indicator is the video frame rate.

Referring to FIG. 7, the electronic device may determine that the first performance indicator associated with the target performance indicator is video resolution and video bit rate. The electronic device may remove the first performance indicator from the plurality of performance indicators to obtain the third performance indicators (there is no multicollinearity problem). The third performance indicators may include video frame rate, device power consumption, occupied memory and device problems. The electronic device may perform linear regression processing on the business indicator and the third performance indicators and obtain the number of daily active users=A×Video frame rate+B×Occupied memory+C×Device power consumption+D×Device temperature. A, B, C and D are the third regression coefficients of the third performance indicators respectively.

In S603. an accuracy of a regression coefficient of each of the performance indicators is verified based on the regression coefficient of the target performance indicator to the business indicator, a plurality of first confidence intervals and the plurality of third regression coefficients.

Verifying the accuracy of the regression coefficient of each of the performance indicators may be verifying the reliability of the regression coefficient of each of the performance indicators to the business indicator. For example, in the process of actual application, although the target performance indicator has a low correlation with other performance indicators, when the target performance indicator is removed for linear regression processing, the regression coefficient of other performance indicators may also be affected. Therefore, it is necessary to determine whether the regression coefficient of other performance indicators changes significantly after the target performance indicator being removed. If the change is large, it means that the reliability of the regression coefficient of the performance indicator obtained by the electronic device is low. If the change is small, it means that the reliability of the regression coefficient of the performance indicator obtained by the electronic device is high.

The electronic device may verify the accuracy of the regression coefficient of each of the performance indicators to the business indicator based on the following feasible implementations: determining a second confidence interval corresponding to the third regression coefficient of the target performance indicator; and verifying the accuracy of the regression coefficient of each of the performance indicators based on the regression coefficient of the target performance indicator to the business indicator, the second confidence interval, the plurality of third regression coefficients and the plurality of first confidence intervals.

The second confidence interval may be the confidence interval of the third regression coefficient of the target performance indicator. For example, when the electronic device determines the plurality of third regression coefficients, because there is a multicollinearity problem between the target performance indicator and the first performance indicator, the electronic device may remove the first performance indicator and retain the target performance indicator to obtain the plurality of third performance indicators (no multicollinearity problem exists). The electronic device may perform multivariable linear regression processing on the business indicator and the plurality of third performance indicators to obtain the third regression coefficients of other performance indicators except the first performance indicator (when the electronic device determines the second regression coefficient, the target performance indicator is removed). Moreover, when the electronic device obtains the third regression coefficients, the second confidence interval corresponding to each of the third regression coefficients may be also obtained. Therefore, the electronic device may obtain the second confidence interval corresponding to the third regression coefficient of the target performance indicator.

It should be noted that the electronic device may also determine the second confidence interval of the third regression coefficient based on any other feasible implementation, and the embodiments of the present disclosure do not limit this.

The electronic device verifies the accuracy of the regression coefficient of each of the performance indicators based on the regression coefficient of the target performance indicator to the business indicator, the second confidence interval, the plurality of third regression coefficients and the plurality of first confidence intervals. Specifically, in response to the regression coefficient of the target performance indicator to the business indicator being within the second confidence interval and each of the third regression coefficients being within a corresponding first confidence interval of the first confidence intervals, it is determined that a verification result of the regression coefficient of each of the performance indicators is passing of the verification; and in response to the regression coefficient of the target performance indicator to the business indicator being out of the second confidence interval or any of the third regression coefficients being out of the corresponding first confidence interval of the first confidence intervals, it is determined that the verification result of the regression coefficient of each performance indicator is a failure of the verification.

For example, if the regression coefficient of the target performance indicator to the business indicator is within the second confidence interval, it means that the regression coefficient of the target performance indicator to the business indicator determined by the electronic device based on the first regression coefficient and the target regression coefficient is more accurate. Moreover, if each of the third regression coefficients is within the corresponding first confidence interval, the electronic device may determine the regression coefficients of other performance indicators other than the target performance indicator with higher accuracy. Therefore, the electronic device may determine that the verification result indicates a passed verification, that is, the reliability of the regression coefficient of each of the performance indicators is relatively high.

For example, if the regression coefficient of the target performance indicator to the business indicator is not within the second confidence interval, it is indicated that the accuracy of the regression coefficient of the target performance indicator to the business indicator determined by the electronic device based on the first regression coefficient and the target regression coefficient is relatively low. Alternatively, any third regression coefficient is not within the corresponding first confidence interval, the electronic device may determine that the accuracy of the regression coefficient of other performance indicators other than the target performance indicator is relatively low, and the electronic device may determine that the verification result indicates a failed verification, that is, after the target performance indicator is removed, the accuracy of the regression coefficients of other obtained performance indicators is relatively low.

The first confidence interval corresponding to the third regression coefficient may be the first confidence interval of the first regression coefficient of the performance indicator corresponding to the third regression coefficient. For example, if the third regression coefficient of the performance indicator is the regression coefficient 1, and the first regression coefficient of the performance indicator is the regression coefficient 2, then if the electronic device determines the regression coefficient 2, a confidence interval may be obtained. If the regression coefficient 1 is within the confidence interval, it indicates that the regression coefficient of the performance indicator is confident.

The embodiments of the present disclosure provide a method of verifying the regression coefficient, including obtaining the first confidence interval corresponding to each second regression coefficient; determining the plurality of third regression coefficients between the business indicators and the plurality of third performance indicators; determining the second confidence interval corresponding to the third regression coefficient of the target performance indicator; verifying the accuracy of the regression coefficient of each of the performance indicators based on the regression coefficient of the target performance indicator to the business indicator, the second confidence interval, the plurality of third regression coefficients and the plurality of first confidence intervals. In this way, the electronic device may remove the first performance indicator, involve the target performance indicator in the regression, and then verify the plurality of regression coefficients obtained by the electronic device based on the third regression coefficient and the first confidence interval to improve the accuracy of the regression coefficient.

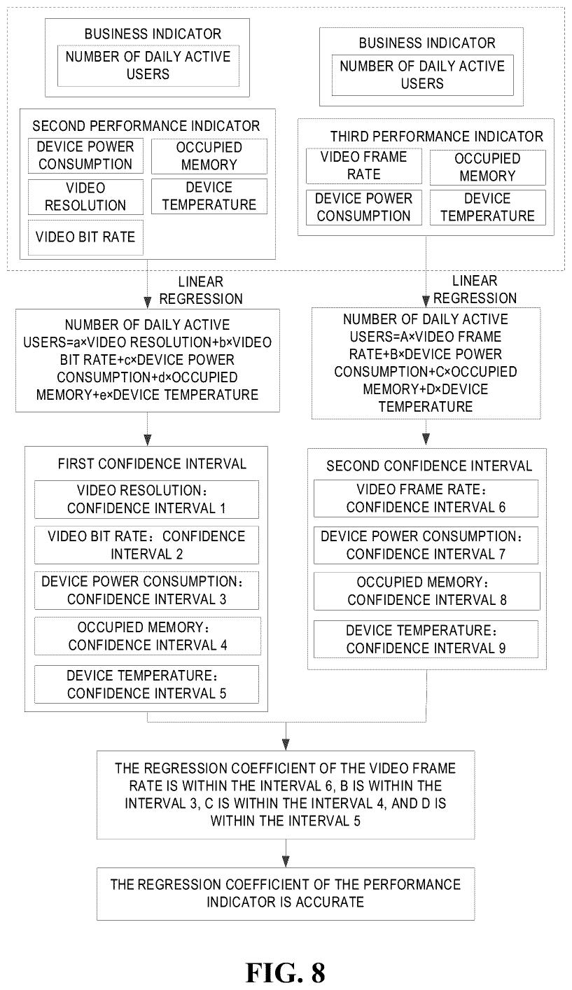

Based on the embodiments shown in FIG. 6, the above-mentioned process of verifying the regression coefficient will be explained below in combination with FIG. 8.

FIG. 8 is a schematic diagram of a process of verifying regression coefficient provided by the embodiments of the present disclosure. Please refer to FIG. 8, which includes: the business indicator, second performance indicators and third performance indicators. The business indicator may be the number of daily active users. The second performance indicators may include device power consumption, video resolution, video bit rate, occupied memory and device temperature, and the third performance indicators may include video frame rate, device power consumption, occupancy memory and device temperature (the target performance indicator is video frame rate, and the first performance indicator is video resolution and video bit rate).

Please refer to FIG. 8, the electronic device (not shown in FIG. 8) may perform linear regression processing on the business indicator and the second performance indicator to obtain Number of daily active users=a×Video resolution+b×Video bit rate+c xDevice power consumption+d×Occupied memory+e×Device temperature, and the first confidence interval. The electronic device performs linear regression processing on the business indicator and the third performance indicator, to obtain Number of daily active users=A×Video frame rate+B×Device power consumption+C×Occupied memory+D×Device temperature, and the second confidence interval.

Referring to FIG. 8, in the first confidence interval, the first confidence interval of the second regression coefficient of the video resolution is interval 1, the first confidence interval of the second regression coefficient of the video bit rate is interval 2, the first confidence interval of the second regression coefficient of the device power consumption is interval 3, the first confidence interval of the second regression coefficient of the occupied memory is interval 4, and the first confidence interval of the second regression coefficient of the device temperature is interval 5. In the second confidence interval, the second confidence interval of the third regression coefficient of the video frame rate is interval 6, the second confidence interval of the third regression coefficient of the device power consumption is interval 7, the second confidence interval of the third regression coefficient of the occupied memory is interval 8, and the second confidence interval of the third regression coefficient of the device temperature is interval 9.

Please refer to FIG. 8, if the regression coefficient of the video frame rate is within the interval 6 (the regression coefficient of the target performance indicator to the business indicator is within the second confidence interval), B is within the interval 3, C is within the interval 4, and D is within the interval 5, then the electronic device may determine the regression coefficient of each performance indicator accurately. That is, after the target performance indicator is removed, the degree of impact on the regression coefficient of other performance indicators is small, the accuracy of the second regression coefficient between other performance indicators and the business indicators is relatively high, and the accuracy of the target performance indicator determined by the electronic device to the regression coefficient of the business indicator is relatively high.

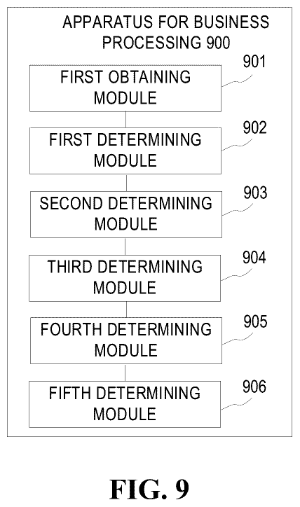

FIG. 9 is a schematic structural diagram of an apparatus for business processing provided by embodiments of the present disclosure. Referring to FIG. 9, the apparatus for business processing 900 includes a first obtaining module 901, a first determining module 902, a second determining module 903, a third determining module 904, a fourth determining module 905 and a fifth determining module 906, where
the first obtaining module 901 is configured to obtain a plurality of performance indicators associated with a business indicator;
the first determining module 902 is configured to determine, in the plurality of performance indicators, a target performance indicator with a multicollinearity problem;
the second determining module 903 is configured to determine a first performance indicator, a correlation of the first performance indicator and the target performance indicator being greater than or equal to a first threshold;
the third determining module 904 is configured to determine a first regression coefficient between the target performance indicator and the first performance indicator;
the fourth determining module 905 is configured to determine a plurality of second regression coefficients between the business indicator and a plurality of second performance indicators, the second performance indicators being performance indicators other than the target performance indicator among the plurality of performance indicators;
the fifth determining module 906 is configured to restore a regression coefficient of the target performance indicator to the business indicator based on the first regression coefficient and the plurality of second regression coefficients, the regression coefficient of the target performance indicator to the business indicator being directly proportional to a degree of impact of the target performance indicator on the business indicator.

According to one or more embodiments of the present disclosure, the fifth determining module 906 is specifically configured to:
for any first performance indicator,
   determine a target regression coefficient associated with the first performance indicator, in the plurality of second regression coefficients; and
   determine a ratio of the target regression coefficient to the first regression coefficient of the first performance indicator as the regression coefficient of the target performance indicator to the business indicator.

According to one or more embodiments of the present disclosure, the fourth determining module 905 is specifically configured to:
remove the target performance indicator from the plurality of performance indicators to obtain the plurality of second performance indicators; and
   perform regression processing on the business indicator and the plurality of second performance indicators to obtain the plurality of second regression coefficients corresponding to the plurality of second performance indicators.

According to one or more embodiments of the present disclosure, the first determining module 902 is specifically configured to:
for any of the performance indicators,
   determine a variance inflation coefficient between the performance indicator and each of other performance indicators of the performance indicators; and
   in response to any variance inflation factor being greater than or equal to a second threshold, determine the performance indicator as the target performance indicator.

The apparatus for business processing provided by the embodiments of the present disclosure may be used to perform the technical solution of the above-mentioned method embodiments. Its implementation principles and technical effects are similar, and the embodiments of the disclosure will not be described in detail here.

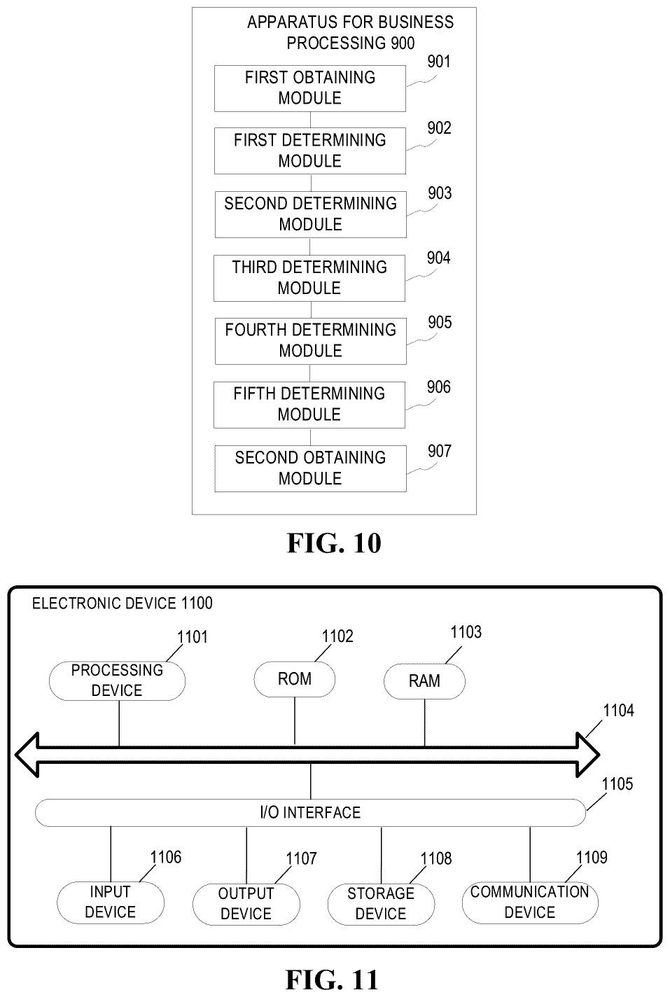

FIG. 10 is a schematic structural diagram of another apparatus for service processing provided by embodiments of the present disclosure. Based on the embodiments shown in FIG. 9, reference is made to FIG. 10 and the apparatus for business processing 900 further includes a second obtaining module 907, where the second obtaining module 907 is configured to:
obtain a first confidence interval corresponding to each of the second regression coefficients;
determine a plurality of third regression coefficients between the business indicator and a plurality of third performance indicators, the third performance indicators comprising performance indicators other than the first performance indicator among the plurality of performance indicators; and
   verify an accuracy of a regression coefficient of each of the performance indicators based on the regression coefficient of the target performance indicator to the business indicator, a plurality of first confidence intervals and the plurality of third regression coefficients.

According to one or more embodiments of the present disclosure, the second obtaining module 907 is specifically configured to:
determine a second confidence interval corresponding to the third regression coefficient of the target performance indicator; and
   verify the accuracy of the regression coefficient of each of the performance indicators based on the regression coefficient of the target performance indicator to the business indicator, the second confidence interval, the plurality of third regression coefficients and the plurality of first confidence intervals.

According to one or more embodiments of the present disclosure, the second obtaining module 907 is specifically configured to:
in response to the regression coefficient of the target performance indicator to the business indicator being within the second confidence interval and each of the third regression coefficients being within a corresponding first confidence interval of the first confidence intervals, determine that a verification result of the regression coefficient of each of the performance indicators is passing of the verification; and
   in response to the regression coefficient of the target performance indicator to the business indicator being out of the second confidence interval or any of the third regression coefficients being out of the corresponding first confidence interval of the first confidence intervals, determine that the verification result of the regression coefficient of each performance indicator is a failure of the verification.

The apparatus for business processing provided by the embodiments of the present disclosure may be used to perform the technical solution of the above-mentioned method embodiments. Its implementation principles and technical effects are similar, and the embodiments of the disclosure will not be described in detail here.

FIG. 11 is a schematic structural diagram of an electronic device provided by embodiments of the present disclosure. Referring to FIG. 11, which illustrates a schematic structural diagram of an electronic device 1100 adapted to implements embodiments of the present application. The terminal devices according to the embodiments of the present application may include, but are not limited to, a mobile terminal such as a mobile phone, a laptop computer, a digital broadcast receiver, a Personal Digital Assistant (PDA), a tablet computer or Portable Android Device (PAD), a Portable Multimedia Player (PMP), or a vehicle-mounted terminal (e.g., a vehicle-mounted navigation terminal), or a fixed terminal such as a digital TV, a desktop computer, etc. The electronic device illustrated in FIG. 11 is only an example and should not be construed as limiting the function and scope of use of the embodiments of the present application.

As illustrated in FIG. 11, the electronic device 1100 may include a processing device (such as a central processing unit, a graphics processing unit, etc.) 1101, which may perform various appropriate actions and processes in accordance with programs stored in a read only memory (ROM) 1102 or loaded from a storage device 1108 into a random access memory (RAM) 1103. In the RAM 1103, various programs and data required for the operation of the electronic device 1100 may also be stored. The processing device 1101, the ROM 1102, and the RAM 1103 are connected to each other through a bus 1104. An input/output (I/O) interface 1105 is also connected to the bus 1104.

Generally, the following devices may be connected to the I/O interface 1105: an input device 1106 including, for example, a touch screen, a touch pad, a keyboard, a mouse, a camera, a microphone, an accelerometer, a gyroscope, etc.; an output device 1107 including, for example, a liquid crystal display (LCD), a speaker, a vibrator, and the like; a storage device 1108 including, for example, magnetic tape, hard disk, etc.; and a communication device 1109. The communication device 1109 may allow the electronic device 1100 to perform wireless or wired communication with other devices for data exchange. Although FIG. 11 illustrates the electronic device 1100 having various devices, it should be understood that it is not necessary to implement or provide all the illustrated devices. Alternatively, more or fewer devices may be implemented or provided.

In particular, according to an embodiment of the present application, the processes described above with reference to the flowcharts may be implemented as computer software programs. For example, an embodiment of the present application includes a computer program product, which includes a computer program carried on a non-transient computer-readable medium. The computer program includes program codes for implementing the method illustrated in any of the flowcharts. In these embodiments, the computer program may be downloaded and installed from a network through the communication device 1109, or installed from the storage device 1108, or installed from the ROM 1102. The computer program, when executed by the processing device 1101, implements the above-mentioned functions defined in the method according to the embodiments of the present application.

It is to be noted that the above computer-readable medium in the present application may be a computer-readable signal medium or a computer-readable storage medium or any combination thereof. The computer-readable storage medium may be, but not limited to, for example, an electrical, magnetic, optical, electromagnetic, infrared, or semiconductor system, apparatus, or device, or any combination thereof. More specific examples of the computer-readable storage medium may include, but not limited to: an electrical connection having one or more wires, a portable computer disk, a hard disk, a random access memory (RAM), a read only memory (ROM), an erasable programmable read only memory (EPROM) or a flash memory, an optical fiber, a compact disc read-only memory (CD-ROM), an optical storage device, a magnetic storage device, or any suitable combination thereof. In the present application, the computer-readable storage medium may be any tangible medium including or storing programs, which may be used by or used with an instruction execution system, apparatus, or device. However, in the present application, the computer-readable signal medium may include a data signal propagated in a baseband or as a part of a carrier that carries computer-readable program codes. Such propagated data signal may be in various forms, including but not limited to an electromagnetic signal, an optical signal, or any suitable combination thereof. The computer-readable signal medium may be any computer-readable medium other than the computer-readable storage medium, which may transmit, propagate, or transfer programs used by or used with an instruction execution system, apparatus or device. The program codes contained on the computer-readable medium may be transmitted via any appropriate medium, including but not limited to electric cable, optical cable, Radio Frequency (RF), or any suitable combination thereof.

The above-mentioned computer-readable medium may be included in the above-mentioned electronic device; it may also exist independently without being assembled into the electronic device.

The computer-readable medium carries one or more programs. When the one or more programs are executed by the electronic device, the electronic device performs the method shown in the above embodiments.

Embodiments of the present disclosure provide a computer-readable storage medium. Computer-executable instructions are stored in the computer-readable storage medium. When the processor executes the computer-executable instructions, various methods possibly involved in the above embodiments are implemented.

Embodiments of the present disclosure provide a computer program product, including a computer program. When the computer program is executed by a processor, various methods possibly involved in the above embodiments are implemented.

The computer program codes for implementing the operations of the present application may be written in one or more programming languages or any combination thereof. The programming languages may include object-oriented programming languages, such as Java, Smalltalk, or C++, as well as conventional procedure-oriented programming languages, such as “C” language or similar programming languages. The program codes may be executed completely on a user computer, partly on the user computer, as a standalone software package, partly on the user computer and partly on a remote computer, or completely on the remote computer or server. In a case where the remote computer is involved, the remote computer may be connected to the user computer through any types of networks, including a Local Area Network (LAN) or a Wide Area Network (WAN), or to an external computer (e.g., over the Internet by using an Internet service provider).

The flowcharts and block diagrams in the accompanying drawings illustrate architectures, functions, and operations of possible implementations of systems, methods, and computer program products according to various embodiments of the present application. In this regard, each block in the flowcharts or block diagrams may represent a module, a program segment, or a part of codes. The module, program segment, or part of codes may contain one or more executable instructions for implementing a specified logical function. It should also be noted that, in some alternative implementations, the functions showed in blocks may occur in an order other than the order illustrated in the drawings. For example, two blocks illustrated in succession may actually be executed substantially in parallel with each other, or sometimes even in a reverse order, depending on functions involved. It should also be noted that each block in the block diagrams and/or flowcharts, or any combination of the blocks in the block diagrams and/or flowcharts, may be implemented using a dedicated hardware-based system configured to perform specified functions or operations or may be implemented using a combination of dedicated hardware and computer instructions.

The units involved in the embodiments described in this application may be implemented in software or hardware. The name of the unit/module does not constitute a limitation on the unit itself under certain circumstances. For example, the first obtaining unit may also be described as “a unit that obtains at least two Internet Protocol addresses.”

The functions described herein above may be performed, at least in part, by one or more hardware logic components. For example, without limitation, exemplary types of suitable hardware logic components include a field programmable gate array (FPGA), an application specific integrated circuit (ASIC), an application specific standard product (ASSP), a system on chip (SOC), a complex programmable logic device (CPLD), and the like.

In the context of this application, a machine-readable medium may be a tangible medium, which may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of a machine-readable storage medium would include an electrical connection having one or more wires, a portable computer disk, a hard disk, a random access memory (RAM), a read only memory (ROM), an erasable programmable read only memory (EPROM) or flash memory, an optical fiber, a compact disc read only memory (CD-ROM), an optical storage device, a magnetic storage device, or any suitable combination thereof. It should be noted that the modifications of “one” and “a plurality of” mentioned in the present disclosure are illustrative and not restrictive. Those skilled in the art will understand that unless the context clearly indicates otherwise, it should be understood as “one or a plurality of”. The names of messages or information exchanged between multiple devices in the embodiments of the present disclosure are for illustrative purposes only and are not used to limit the scope of these messages or information. It may be understood that before using the technical solutions disclosed in each embodiment of the present disclosure, users should be informed of the type, scope of use, usage scenarios, etc. of the personal information involved in the present disclosure in an appropriate manner in accordance with relevant laws and regulations, and their authorization should be obtained.

For example, in response to receiving an active request from a user, a prompt message is sent to the user to clearly remind the user that the operation requested will require obtaining and using the personal information of a user. Therefore, users may autonomously choose whether to provide personal information to software or hardware such as electronic devices, applications, servers or storage medium that perform the operations of the technical solution of the present disclosure based on the prompt information. As an optional but non-limiting implementation, in response to receiving an active request of a user, the approach of sending prompt information to the user may be, for example, popping up a window, and the prompt information may be presented in the form of text in the pop-up window. In addition, the pop-up window may also contain a selection control for the user to choose “agree” or “disagree” to provide personal information to the electronic device.

It may be understood that the above notification and obtaining user authorization processes are only illustrative and do not limit the implementation of the present disclosure. Other approaches that satisfy relevant laws and regulations may also be applied to the implementation of the present disclosure.

It may be understood that the data involved in this technical solution (including but not limited to the data itself, the obtaining or use of the data) should comply with the requirements of corresponding laws, regulations and related regulations. Data can include information, parameters, messages, etc., such as flow switching instruction information.

In a first aspect, according to one or more embodiments of the present disclosure, the present disclosure includes a method for business processing and the method includes:
obtaining a plurality of performance indicators associated with a business indicator;
determining, in the plurality of performance indicators, a target performance indicator with a multicollinearity problem;
determining a first performance indicator, a correlation of the first performance indicator and the target performance indicator being greater than or equal to a first threshold;
determining a first regression coefficient between the target performance indicator and the first performance indicator;
determining a plurality of second regression coefficients between the business indicator and a plurality of second performance indicators, the second performance indicators being performance indicators other than the target performance indicator among the plurality of performance indicators; and
   restoring a regression coefficient of the target performance indicator to the business indicator based on the first regression coefficient and the plurality of second regression coefficients, the regression coefficient of the target performance indicator to the business indicator being directly proportional to a degree of impact of the target performance indicator on the business indicator.

According to one or more embodiments of the present disclosure, restoring a regression coefficient of the target performance indicator to the business indicator based on the first regression coefficient and the plurality of second regression coefficients comprises:
for any first performance indicator,
   determining a target regression coefficient associated with the first performance indicator, in the plurality of second regression coefficients; and
   determining a ratio of the target regression coefficient to the first regression coefficient of the first performance indicator as the regression coefficient of the target performance indicator to the business indicator.

According to one or more embodiments of the present disclosure, determining a plurality of second regression coefficients between the business indicator and a plurality of second performance indicators comprises:
removing the target performance indicator from the plurality of performance indicators to obtain the plurality of second performance indicators; and
   performing regression processing on the business indicator and the plurality of second performance indicators to obtain the plurality of second regression coefficients corresponding to the plurality of second performance indicators.

According to one or more embodiments of the present disclosure, determining, in the plurality of performance indicators, a target performance indicator with a multicollinearity problem comprises:
for any of the performance indicators,
   determining a variance inflation coefficient between the performance indicator and each of other performance indicators of the performance indicators; and
   in response to any variance inflation factor being greater than or equal to a second threshold, determining the performance indicator as the target performance indicator.

According to one or more embodiments of the present disclosure, the method further comprises after determining the regression coefficient of the target performance indicator to the business indicator,
obtaining a first confidence interval corresponding to each of the second regression coefficients;
determining a plurality of third regression coefficients between the business indicator and a plurality of third performance indicators, the third performance indicators comprising performance indicators other than the first performance indicator among the plurality of performance indicators; and
   verifying an accuracy of a regression coefficient of each of the performance indicators based on the regression coefficient of the target performance indicator to the business indicator, a plurality of first confidence intervals and the plurality of third regression coefficients.

According to one or more embodiments of the present disclosure, verifying an accuracy of a regression coefficient of each of the performance indicators based on the regression coefficient of the target performance indicator to the business indicator, a plurality of first confidence intervals and the plurality of third regression coefficients comprises:
determining a second confidence interval corresponding to the third regression coefficient of the target performance indicator; and
   verifying the accuracy of the regression coefficient of each of the performance indicators based on the regression coefficient of the target performance indicator to the business indicator, the second confidence interval, the plurality of third regression coefficients and the plurality of first confidence intervals.

According to one or more embodiments of the present disclosure, verifying the accuracy of the regression coefficient of each of the performance indicators based on the regression coefficient of the target performance indicator to the business indicator, the second confidence interval, the plurality of third regression coefficients and the plurality of first confidence intervals comprises:
in response to the regression coefficient of the target performance indicator to the business indicator being within the second confidence interval and each of the third regression coefficients being within a corresponding first confidence interval of the first confidence intervals, determining that a verification result of the regression coefficient of each of the performance indicators is passing of the verification; and
   in response to the regression coefficient of the target performance indicator to the business indicator being out of the second confidence interval or any of the third regression coefficients being out of the corresponding first confidence interval of the first confidence intervals, determining that the verification result of the regression coefficient of each performance indicator is a failure of the verification.

In a second aspect, according to one or more embodiments of the present disclosure, the embodiments of the present disclosure provide an apparatus for business processing. The apparatus for business processing includes a first obtaining module, a first determining module, a second determining module, a third determining module, a fourth determining module and a fifth determining module, where:
the first obtaining module is configured to obtain a plurality of performance indicators associated with a business indicator;
the first determining module is configured to determine, in the plurality of performance indicators, a target performance indicator with a multicollinearity problem;
the second determining module is configured to determine a first performance indicator, a correlation of the first performance indicator and the target performance indicator being greater than or equal to a first threshold;
the third determining module is configured to determine a first regression coefficient between the target performance indicator and the first performance indicator;
the fourth determining module is configured to determine a plurality of second regression coefficients between the business indicator and a plurality of second performance indicators, the second performance indicators being performance indicators other than the target performance indicator among the plurality of performance indicators; and
   the fifth determining module is configured to restore a regression coefficient of the target performance indicator to the business indicator based on the first regression coefficient and the plurality of second regression coefficients, the regression coefficient of the target performance indicator to the business indicator being directly proportional to a degree of impact of the target performance indicator on the business indicator.

According to one or more embodiments of the present disclosure, the fifth determining module is specifically configured to:
for any first performance indicator,
   determine a target regression coefficient associated with the first performance indicator, in the plurality of second regression coefficients; and
   determine a ratio of the target regression coefficient to the first regression coefficient of the first performance indicator as the regression coefficient of the target performance indicator to the business indicator.

According to one or more embodiments of the present disclosure, the fourth determining module is specifically configured to:
remove the target performance indicator from the plurality of performance indicators to obtain the plurality of second performance indicators; and
   perform regression processing on the business indicator and the plurality of second performance indicators to obtain the plurality of second regression coefficients corresponding to the plurality of second performance indicators.

According to one or more embodiments of the present disclosure, the first determining module is specifically configured to:
for any of the performance indicators,
   determine a variance inflation coefficient between the performance indicator and each of other performance indicators of the performance indicators; and
   in response to any variance inflation factor being greater than or equal to a second threshold, determine the performance indicator as the target performance indicator.

According to one or more embodiments of the present disclosure, the apparatus for business processing further includes a second obtaining module, where the second obtaining module is configured to:
obtain a first confidence interval corresponding to each of the second regression coefficients;
determine a plurality of third regression coefficients between the business indicator and a plurality of third performance indicators, the third performance indicators comprising performance indicators other than the first performance indicator among the plurality of performance indicators; and
   verify an accuracy of a regression coefficient of each of the performance indicators based on the regression coefficient of the target performance indicator to the business indicator, a plurality of first confidence intervals and the plurality of third regression coefficients.

According to one or more embodiments of the present disclosure, the second obtaining module is specifically configured to:
determine a second confidence interval corresponding to the third regression coefficient of the target performance indicator; and
   verify the accuracy of the regression coefficient of each of the performance indicators based on the regression coefficient of the target performance indicator to the business indicator, the second confidence interval, the plurality of third regression coefficients and the plurality of first confidence intervals.

According to one or more embodiments of the present disclosure, the second obtaining module is specifically configured to:
in response to the regression coefficient of the target performance indicator to the business indicator being within the second confidence interval and each of the third regression coefficients being within a corresponding first confidence interval of the first confidence intervals, determine that a verification result of the regression coefficient of each of the performance indicators is passing of the verification; and
in response to the regression coefficient of the target performance indicator to the business indicator being out of the second confidence interval or any of the third regression coefficients being out of the corresponding first confidence interval of the first confidence intervals, determine that the verification result of the regression coefficient of each performance indicator is a failure of the verification.

In a third aspect, embodiments of the present disclosure provide a terminal device including: a processor and a memory;
where the memory stores a computer-executed instruction;
the processor executes the computer-executed instruction stored in the memory, causing the at least one processor executes the method of above first aspect and various methods possibly involved in the first aspect.

In a fourth aspect, embodiments of the present disclosure provide a computer-readable storage medium and the computer-readable storage medium stores a computer-executed instruction, and the computer-executed instruction, when executed by a processor, implements the method of above first aspect and various methods possibly involved in the first aspect.

The above description is only intended to explain the preferred embodiments of the present disclosure and the employed principles of the technology. It will be appreciated by those skilled in the art that the scope of the present disclosure herein is not limited to the technical solutions formed by the specific combination of the above technical features but should also encompass any other combinations of features described above or equivalents thereof without departing from the above idea of the present disclosure. For example, the above features and the technical features disclosed in the present disclosure having similar functions (but not limited to them) are replaced with each other to form the technical solution.

Further, although the operations are depicted in a specific order, this should not be understood as requiring these operations to be performed in the specific order illustrated or in a sequential order. Under certain circumstances, multitasking and parallel processing may be advantageous. Likewise, although several specific implementation details are included in the above discussion, these should not be construed as limitations on the scope of the present disclosure. Certain features that are described in the context of separate embodiments can also be implemented in combination in a single embodiment. On the contrary, various features described in the context of a single embodiment can also be implemented in multiple embodiments separately or in any suitable combination.

Although the subject matter has been described in language specific to structural features and/or logical actions of the method, it should be understood that the subject matter defined in the appended claims is not necessarily limited to the specific features or actions described above. On the contrary, the specific features and actions described above are merely example forms of implementing the claims.

1. A method of business processing, comprising:
obtaining a plurality of performance indicators associated with a business indicator;
determining, in the plurality of performance indicators, a target performance indicator with a multicollinearity problem;
determining a first performance indicator, a correlation of the first performance indicator and the target performance indicator being greater than or equal to a first threshold;
determining a first regression coefficient between the target performance indicator and the first performance indicator;
determining a plurality of second regression coefficients between the business indicator and a plurality of second performance indicators, the second performance indicators being performance indicators other than the target performance indicator among the plurality of performance indicators; and
restoring a regression coefficient of the target performance indicator to the business indicator based on the first regression coefficient and the plurality of second regression coefficients, the regression coefficient of the target performance indicator to the business indicator being directly proportional to a degree of impact of the target performance indicator on the business indicator.

2. The method of claim 1, wherein the restoring a regression coefficient of the target performance indicator to the business indicator based on the first regression coefficient and the plurality of second regression coefficients comprises:
for any first performance indicator,
determining a target regression coefficient associated with the first performance indicator, in the plurality of second regression coefficients; and
determining a ratio of the target regression coefficient to the first regression coefficient of the first performance indicator as the regression coefficient of the target performance indicator to the business indicator.

3. The method of claim 1, wherein the determining a plurality of second regression coefficients between the business indicator and a plurality of second performance indicators comprises:
removing the target performance indicator from the plurality of performance indicators to obtain the plurality of second performance indicators; and
performing regression processing on the business indicator and the plurality of second performance indicators to obtain the plurality of second regression coefficients corresponding to the plurality of second performance indicators.

4. The method of claim 1, wherein the determining, in the plurality of performance indicators, a target performance indicator with a multicollinearity problem comprises:
for any of the performance indicators,
determining a variance inflation coefficient between the performance indicator and each of other performance indicators of the performance indicators; and
in response to any variance inflation factor being greater than or equal to a second threshold, determining the performance indicator as the target performance indicator.

5. The method of claim 1, wherein the method further comprises after determining the regression coefficient of the target performance indicator to the business indicator,
obtaining a first confidence interval corresponding to each of the second regression coefficients;
determining a plurality of third regression coefficients between the business indicator and a plurality of third performance indicators, the third performance indicators comprising performance indicators other than the first performance indicator among the plurality of performance indicators; and
verifying an accuracy of a regression coefficient of each of the performance indicators based on the regression coefficient of the target performance indicator to the business indicator, a plurality of first confidence intervals and the plurality of third regression coefficients.

6. The method of claim 5, wherein the verifying an accuracy of a regression coefficient of each of the performance indicators based on the regression coefficient of the target performance indicator to the business indicator, a plurality of first confidence intervals and the plurality of third regression coefficients comprises:
determining a second confidence interval corresponding to the third regression coefficient of the target performance indicator; and
verifying the accuracy of the regression coefficient of each of the performance indicators based on the regression coefficient of the target performance indicator to the business indicator, the second confidence interval, the plurality of third regression coefficients and the plurality of first confidence intervals.

7. The method of claim 6, wherein the verifying the accuracy of the regression coefficient of each of the performance indicators based on the regression coefficient of the target performance indicator to the business indicator, the second confidence interval, the plurality of third regression coefficients and the plurality of first confidence intervals comprises:
in response to the regression coefficient of the target performance indicator to the business indicator being within the second confidence interval and each of the third regression coefficients being within a corresponding first confidence interval of the first confidence intervals, determining that a verification result of the regression coefficient of each of the performance indicators is passing of the verification; and
in response to the regression coefficient of the target performance indicator to the business indicator being out of the second confidence interval or any of the third regression coefficients being out of the corresponding first confidence interval of the first confidence intervals, determining that the verification result of the regression coefficient of each performance indicator is a failure of the verification.

8. An electronic device, comprising: a processor and a memory;
wherein the memory stores a computer-executed instruction; and
the processor executes the computer-executed instruction stored in the memory, causing the processor to perform operations comprising:
obtaining a plurality of performance indicators associated with a business indicator;
determining, in the plurality of performance indicators, a target performance indicator with a multicollinearity problem;
determining a first performance indicator, a correlation of the first performance indicator and the target performance indicator being greater than or equal to a first threshold;
determining a first regression coefficient between the target performance indicator and the first performance indicator;
determining a plurality of second regression coefficients between the business indicator and a plurality of second performance indicators, the second performance indicators being performance indicators other than the target performance indicator among the plurality of performance indicators; and
restoring a regression coefficient of the target performance indicator to the business indicator based on the first regression coefficient and the plurality of second regression coefficients, the regression coefficient of the target performance indicator to the business indicator being directly proportional to a degree of impact of the target performance indicator on the business indicator.

9. The electronic device of claim 8, wherein the restoring a regression coefficient of the target performance indicator to the business indicator based on the first regression coefficient and the plurality of second regression coefficients comprises:
for any first performance indicator,
determining a target regression coefficient associated with the first performance indicator, in the plurality of second regression coefficients; and
determining a ratio of the target regression coefficient to the first regression coefficient of the first performance indicator as the regression coefficient of the target performance indicator to the business indicator.

10. The electronic device of claim 8, wherein the determining a plurality of second regression coefficients between the business indicator and a plurality of second performance indicators comprises:
removing the target performance indicator from the plurality of performance indicators to obtain the plurality of second performance indicators; and
performing regression processing on the business indicator and the plurality of second performance indicators to obtain the plurality of second regression coefficients corresponding to the plurality of second performance indicators.

11. The electronic device of claim 8, wherein the determining, in the plurality of performance indicators, a target performance indicator with a multicollinearity problem comprises:
for any of the performance indicators,
determining a variance inflation coefficient between the performance indicator and each of other performance indicators of the performance indicators; and
in response to any variance inflation factor being greater than or equal to a second threshold, determining the performance indicator as the target performance indicator.

12. The electronic device of claim 8, wherein the method further comprises after determining the regression coefficient of the target performance indicator to the business indicator,
obtaining a first confidence interval corresponding to each of the second regression coefficients;
determining a plurality of third regression coefficients between the business indicator and a plurality of third performance indicators, the third performance indicators comprising performance indicators other than the first performance indicator among the plurality of performance indicators; and
verifying an accuracy of a regression coefficient of each of the performance indicators based on the regression coefficient of the target performance indicator to the business indicator, a plurality of first confidence intervals and the plurality of third regression coefficients.

13. The electronic device of claim 12, wherein the verifying an accuracy of a regression coefficient of each of the performance indicators based on the regression coefficient of the target performance indicator to the business indicator, a plurality of first confidence intervals and the plurality of third regression coefficients comprises:
determining a second confidence interval corresponding to the third regression coefficient of the target performance indicator; and
verifying the accuracy of the regression coefficient of each of the performance indicators based on the regression coefficient of the target performance indicator to the business indicator, the second confidence interval, the plurality of third regression coefficients and the plurality of first confidence intervals.

14. The electronic device of claim 13, wherein the verifying the accuracy of the regression coefficient of each of the performance indicators based on the regression coefficient of the target performance indicator to the business indicator, the second confidence interval, the plurality of third regression coefficients and the plurality of first confidence intervals comprises:
in response to the regression coefficient of the target performance indicator to the business indicator being within the second confidence interval and each of the third regression coefficients being within a corresponding first confidence interval of the first confidence intervals, determining that a verification result of the regression coefficient of each of the performance indicators is passing of the verification; and
in response to the regression coefficient of the target performance indicator to the business indicator being out of the second confidence interval or any of the third regression coefficients being out of the corresponding first confidence interval of the first confidence intervals, determining that the verification result of the regression coefficient of each performance indicator is a failure of the verification.

15. A non-transitory computer-readable storage medium, wherein the computer-readable storage medium stores a computer-executed instruction, and the computer-executed instruction, when executed by a processor, implements operations comprising:
obtaining a plurality of performance indicators associated with a business indicator;
determining, in the plurality of performance indicators, a target performance indicator with a multicollinearity problem;
determining a first performance indicator, a correlation of the first performance indicator and the target performance indicator being greater than or equal to a first threshold;
determining a first regression coefficient between the target performance indicator and the first performance indicator;
determining a plurality of second regression coefficients between the business indicator and a plurality of second performance indicators, the second performance indicators being performance indicators other than the target performance indicator among the plurality of performance indicators; and
restoring a regression coefficient of the target performance indicator to the business indicator based on the first regression coefficient and the plurality of second regression coefficients, the regression coefficient of the target performance indicator to the business indicator being directly proportional to a degree of impact of the target performance indicator on the business indicator.

16. The non-transitory computer-readable storage medium of claim 15, wherein the restoring a regression coefficient of the target performance indicator to the business indicator based on the first regression coefficient and the plurality of second regression coefficients comprises:
for any first performance indicator,
determining a target regression coefficient associated with the first performance indicator, in the plurality of second regression coefficients; and
determining a ratio of the target regression coefficient to the first regression coefficient of the first performance indicator as the regression coefficient of the target performance indicator to the business indicator.

17. The non-transitory computer-readable storage medium of claim 15, wherein the determining a plurality of second regression coefficients between the business indicator and a plurality of second performance indicators comprises:
removing the target performance indicator from the plurality of performance indicators to obtain the plurality of second performance indicators; and
performing regression processing on the business indicator and the plurality of second performance indicators to obtain the plurality of second regression coefficients corresponding to the plurality of second performance indicators.

18. The non-transitory computer-readable storage medium of claim 15, wherein the determining, in the plurality of performance indicators, a target performance indicator with a multicollinearity problem comprises:
for any of the performance indicators,
determining a variance inflation coefficient between the performance indicator and each of other performance indicators of the performance indicators; and
in response to any variance inflation factor being greater than or equal to a second threshold, determining the performance indicator as the target performance indicator.

19. The non-transitory computer-readable storage medium of claim 15, wherein the method further comprises after determining the regression coefficient of the target performance indicator to the business indicator,
obtaining a first confidence interval corresponding to each of the second regression coefficients;
determining a plurality of third regression coefficients between the business indicator and a plurality of third performance indicators, the third performance indicators comprising performance indicators other than the first performance indicator among the plurality of performance indicators; and
verifying an accuracy of a regression coefficient of each of the performance indicators based on the regression coefficient of the target performance indicator to the business indicator, a plurality of first confidence intervals and the plurality of third regression coefficients.

20. The non-transitory computer-readable storage medium of claim 16, wherein the verifying an accuracy of a regression coefficient of each of the performance indicators based on the regression coefficient of the target performance indicator to the business indicator, a plurality of first confidence intervals and the plurality of third regression coefficients comprises:
determining a second confidence interval corresponding to the third regression coefficient of the target performance indicator; and
verifying the accuracy of the regression coefficient of each of the performance indicators based on the regression coefficient of the target performance indicator to the business indicator, the second confidence interval, the plurality of third regression coefficients and the plurality of first confidence intervals.
